(19) United States
(12) Patent Application Publication
(10) Pub. No.: US 2013/0040596 A1
(43) Pub. Date: Feb. 14, 2013

(54) METHOD FOR USING SMARTPHONES AS PUBLIC AND PERSONAL SECURITY DEVICES BASED ON TRUSTED SOCIAL NETWORKS

(71) Applicants: Sergio Garcia Paim, Uberlandia (BR); Wladimir Fernandes de Rezende, Uberlandia (BR)

(72) Inventors: Sergio Garcia Paim, Uberlandia (BR); Wladimir Fernandes de Rezende, Uberlandia (BR)

(73) Assignee: INVIT INFORMATION SERVICES LTDA, Uberlandia (BR)

(21) Appl. No.: 13/208,710

(22) Filed: Aug. 12, 2011

(51) Int. Cl. H04W 4/22; H04W 12/00; H04W 24/00

(52) U.S. Cl. 455/404.1; 455/418; 455/410

(57) ABSTRACT

Smartphones have increasingly been used for individual and collective protection, despite the lack of specialized methods and solutions capable of extracting all the hidden potential of the junction of hardware, software and people.

Effectively having those devices as instruments for triggering and coordinating individual and collective reactions to crises and threats requires a practical and integrated design, whereas different aspects must be considered. The present invention allows a smartphone user to easily and properly share his status during distress situations with people who can better help him contextually and reliably.

### TECHNICAL FIELD

The present invention relates to the field of security and surveillance devices, more specifically to the conversion of a generic smartphone into a security device through mobile applications and corresponding web services.

This present invention refers to an automatic method that allows users and helpers to collaborate in real-time during distress situations. It comprises techniques, usability designs, methods and functionalities that altogether make it possible a disruptive way of providing personal and public security.

### BACKGROUND OF THE INVENTION

There are many disparate resources and/or solutions intended to provide tracking and protection, ranging from simple mobile applications to broad systems for family protection and surveillance.

The iPhone Application Silent Bodyguard available at http://itunes.apple.com/us/app/silent-bodvquard-your-personal/id347506878?mt=8 is one of these simple mobile applications. For informing emercy situations that the user is currently experiencing, this application sends e-mails and/or SMS messages to pre-registered users.

Examples of systems for family protection and surveillance are Life360 and Neer. Life360 is available at http://www.life360.com/, whereas Neer can be found at http://wvvw.neerlife.com.

Application Life360 provides functionality to turn a mobile phone into a family safety device, comprising features such as locating your family using GPS on a map; checking in to let family members know you are ok; viewing safety points and threads that may be nearby; knowing when anyone in your family is safe or needs help.

Neer is an application for mobile phones which uses the phone's location to provide location reminders, upon setting location aware of a task to do and the phone will buzz next time you get there. Neer also share your location privately with your Inner Circle friends. Therefore, Neer will share the places chosen by the user only with selected people.

Nonetheless, none of these systems have a proactive and systematic approach to handle threating situations like the present invention does, in particular during crime situations likely to coercion. The comprehensive set of design decisions regarding the present invention was made considering the specific problems derived from that goal.

For instance, the mechanisms for triggering panic (i.e. buttons) usually found in other solutions are pretty basic because there are no greater concerns on false positives, since the propagation of a help call is done by simple direct messages to known persons, without the presumption to aware the nearby and/or distant multitude.

Regarding sensing capabilities, there are essentially tracking solutions based only on the location resources natively provided by smartphones (GPS and others), without trying to control user's state (safety and comfort) in order to adjust the level of monitoring of the application and to provide an important subjective signal for further automatic and human reactions.

Either there are not security checks at all in current solutions or they are conventional mechanisms originated from building alarms systems such as secret pair of words, anti-coercion word, anti-coercion (different) password or password inversion for coercion. Those are mechanisms best suited for standard alarm appliances, but not convenient and effective for mobile and personal use.

Last but not least, no solution nowadays has the capability to trustfuly, fastly and effectively propagate the help call to potential helpers surrounding the event, even to unknown and/or unregistered ones.

There are imperative privacy concerns denying simple broadcast of user's position and other sensitive information and, currently, no other security solution has overcome them, as shown above.

### SUMMARY OF THE INVENTION

Smartphones are becoming ubiquitous, have many sensors for various purposes including location, are permanently connected to the Internet and they are most of the time pretty close and available to their users.

The term “Smartphones” as herein used should not be limited to a mobile phone only. Although a smartsphone is a device that combines the functions of a personal digital assistant (PDA) and a mobile phone, which currently also serve as portable media players and camera phones with high-resolution touchscreen, GPS navigation, Wi-Fi and mobile broadband access. The term smartphone as herein used may include any other portable devices with more advanced computing ability and connectivity than a contemporary phone, such as positioning resources, internet contectivity and sensors as camera, microfone and accelerometer.

Social networks formed and served by web services are also often used for broadcasting of warning and advice messages, coming from individuals and/or public services.

Together, social networks and smartphones are turning into important instruments for social awareness, contributing to the society and citizens all around the world.

Nevertheless there is still a huge lack of trust, intelligence and privacy regarding those inadvertent protection services, which, in turn, limits so much their applicable scenarios.

The present invention comes from the recognition that in any threatening situation, being caused by a collapse, accident, natural disaster or crime, the sooner the help call is captured and responded, the better the outcome is.

Hence, the present invention comprises means of digitally calling for help that can reach nearest and farthest helpers available in a quick, precise and up-to-date manner. The present invention is also capable to do that still preserving the natural levels of confidence a common call (only spoken, human-to-human) would have—including the ability of differentiating helpers from accomplices during crime situations.

First, the present invention represents trust relationships between users in a reciprocal way, building a small but strong graph of trust.

Then, the present invention gives the user control over the level of background monitoring his or her smartphone would do as the user selects between statuses that represent his or her contextual/situational needs by implicit semantics.

An usability resource is part of the present invention in order to provide users with an easy and quick way to call for help (panic) still avoiding unintentional triggering—a classical design trade-off in any critical control.

Another usability resource provided by the present invention is a convenient, easy to memorize, easy to use and hard to fraud mechanism for security check. This mechanism will be used in any transaction that could mean a security breach and be object of user's coercion (e.g. panic cancelation).

The present invention also covers the method for digitally notification of potential helpers, including location-aware decisions considering privacy needs and coercion potential.

Said method is supported by a functionality the present invention has that allows the user (or a trusted friend) to share his or her (user) Situation Room with anybody he would contact for help, personally, via text (SMS, e-mail, etc.) or a voice call (e.g. calling emergency service, 911). According to the present invention, the mentioned Situation Room relates to the real-time information book accessible via Web regarding the call, such as current position, personal description, people of contact/trust, etc.

Differently from other solutions focused on tracking people and things, the present invention is mainly dedicated to boost the social responsiveness against individual emergencies, including collapses, accidents, natural disasters and crimes.

One of the main purposes of the present invention is to serve as a fundamental counterpart of the traditional emergency channels available in urban environments, allowing citizens to quickly set a digital bidirectional link with any potential helper, been it private or public.

It is important to note that such a link does not mandate pre-registry of the helper, leading to an easy-to-deploy global solution dependent only on the need and will of users (not of emergency services worldwide).

Specifically regarding crime situations, the present invention natively considers the possibility of users (and potential witnesses) coercion, which would ultimately make it impossible to capture and broadcast the help calls. So, it offers a silent panic feature that does not give any evidence to a coercer that a help call was made, despite the fact that the call would have been broadcasted outside the coercion zone. That would benefit so much the chances for help, including in hard noting-and-responding domestic and intimate partner violence situations.

The same coercion concern is present during open help calls (private or public panics) since a coercer could then force the user to cancel the call. A failed anti-coercion test would close the open help call and start a silent one.

Another critical scenario treated by the present invention is when a user is surprised by a crime threat so he does not have enough time to trigger the panic. The present invention has the aptitude to be set in alert state, thus providing rapid panic triggering capabilities through bypassing graphical-touch-button interfaces—based on sounds and movements (captured by microphone and accelerometer) by the smartphone application when on that state.

### Technical/Functional Advantages

### Anti-Coercion Zones

The present invention is able to select whom to send the help call considering the epicenter of the incident, the current location of potential known helpers and witnesses, as well as the type of the panic.

### Triggering Usability

The present invention has an unique design for panic triggering (and state switching) that both ease the action for the user and avoid unwanted false positives.

### Effective Security Check

The present invention features a distinctive mechanism for anti-coercion check that is easy to memorize and to use, as well as still is trustworthy enough for use in such critical situations as the present inventions' purpose.

### Alert State Monitoring

The present invention has an unprecedented alert state that allows the user to point out whether he is about to face a possible distress situation. In such state, the present invention would dismiss the user of triggering panic on certain circumstances. The state also represents a valuable sign from the user about his or her context, greatly improving automatic and human capacity of predictive protection,

### Shareable Situation Room

The present invention provides matchless mechanism and method for sharing real-time information about the user in distress that would behave as dynamic pointers to the threat to whoever could help. Those pointers are bidirectional channels between users, witnesses and helpers (professional or not) and perform as great instruments for social response and coordination.

### BRIEF DESCRIPTION OF THE DRAWINGS

The present invention will be promptly understood by the following detailed description in conjunction with the accompanying drawings, wherein like reference numerals designate like structural and/or behavioral elements of the present invention, in which:

FIG. 1 depicts a schematic threatening situation that the present invention is intended to work. It describes the archetypal roles involved, regions of interaction with the situation and the types of possible help calls.

FIG. 2 depicts the internal states that the mobile application (running on a generic smartphone) could be in, as well as the relating awareness (level of monitoring) of the application and its corresponding web services.

FIG. 3 depicts a usability resource and functionality for state switching and for help calling, both in a natural, intuitive and reliant manner.

FIG. 4 depicts a usability and functionality resource for security check against coercion situations flexible and simple enough to be used several times a day without disturbing the user.

FIG. 5 depicts a method for catching and notification of a threat and coordination of help in real-time considering privacy needs and trust relations among known and unknown users.

FIG. 6 depicts a method for sensing the user environment through smartphone's microphone and accelerometer when the present invention's mobile application is on alert state.

FIG. 7 depicts a method for predictive protection of the user based on his use of alert state feature of the present invention, as well as based on the consolidated history of other users.

### DESCRIPTION OF THE PREFERABLE EMBODIMENT OF THE INVENTION

As noted above, offering smartphone users an instrument for calling help conveniently and reliably is an important and valuable issue. Conventionally, this space is filled by fragmented, standard or improvised solutions which fail to achieve remarkable effectiveness.

Accordingly, the present invention provides techniques, usability designs, methods and functionalities that allow users and helpers to collaborate in real-time during distress situations which can dramatically improve security both personal and public.

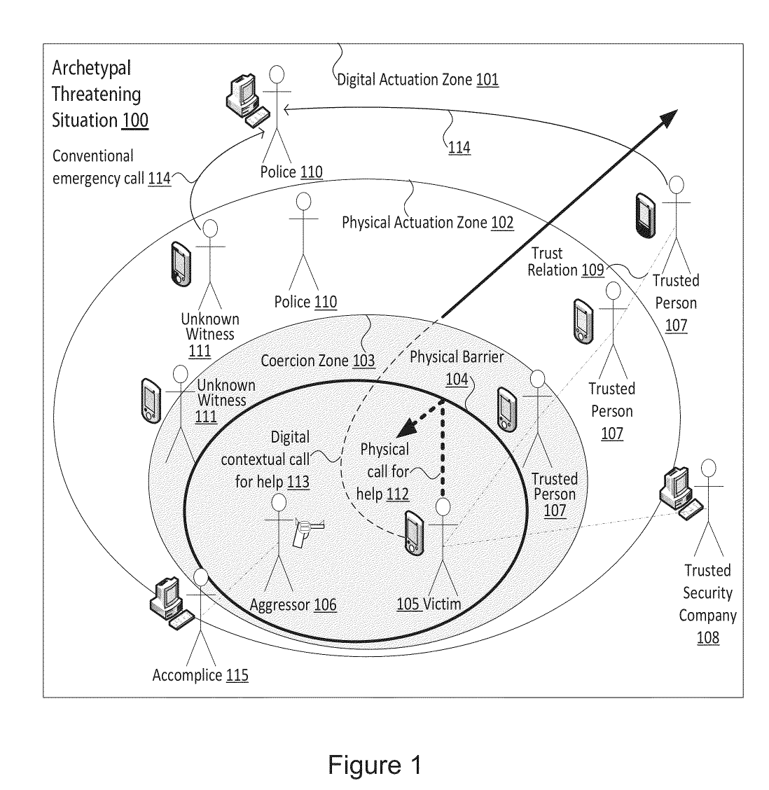

Embodiments of the innovative aspects of the present invention can be appreciated by the discussion below with reference to FIG. 1 and then to the remaining figures. However, those skilled in the art will promptly appreciate that the detailed description given herein with respect to these figures is for explanatory purposes only as the present invention extends beyond these limited embodiments.

FIG. 1 depicts an archetypal distress situation 100 that a user 105 is facing. In particular, and for illustrative purpose only, the situation described herein is a threatening crime scene (e.g. an armed robbery) in which there is at least one aggressor 106 and hehas the power by force to coerce the victim 105 or put his or her life at risk.

FIG. 1 also depicts archetypal zones of awareness of the scene where the bigger zones contain the smaller ones, namely: physical barrier 104 represents the visual and hearing limit that blocks a physical call for help 112; coercion zone 103 is the region where any witness 111, 107 trying to help could likely become another victim and give the aggressor 106 notice that a help response has been triggered; physical actuation zone 102 is the region where a physical help can start from; digital actuation zone 101 is the region (potentially the entire globe, limited only by availability of Internet access) where anyone with access to the digital call for help 113 (and its shareable situation room 508) could collaborate with the physical help, initiating it 114 and feeding it with contextual real-time information.

The situation 100 considers that, during any critical occurrence, the help mobilization to around it would best follow the proximity and the level of trust between people 109. Obviously, such mobilization would happen for the good (107, 108, 111 and 110) and for the bad 115.

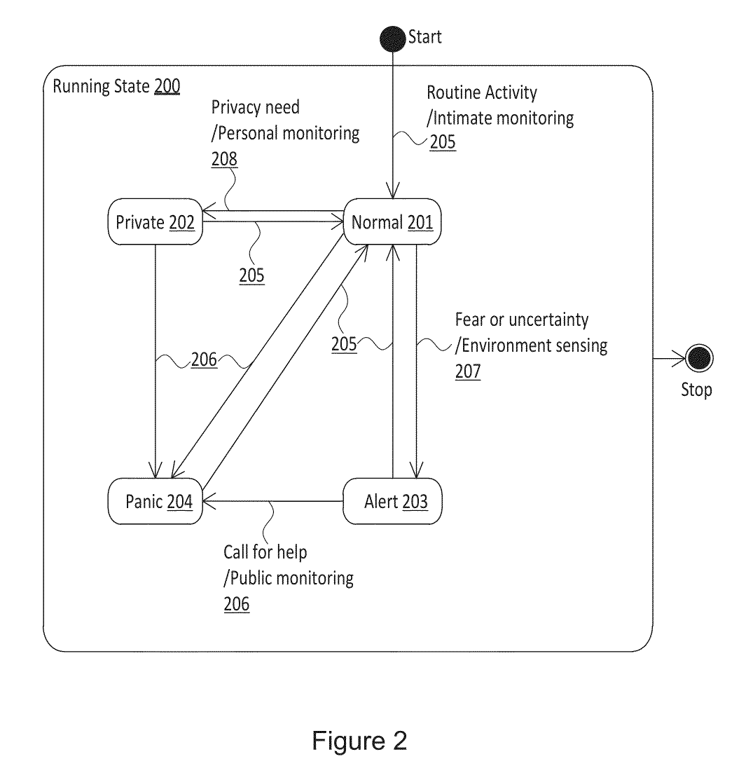

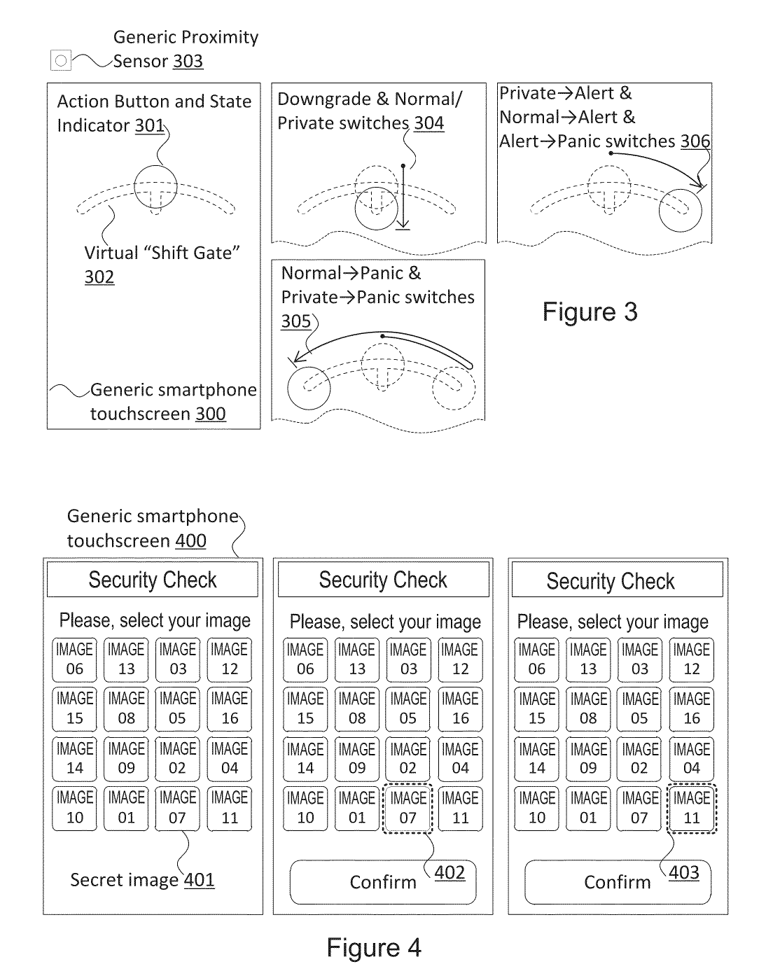

Consequently, a digital contextual call for help 113 would be easily annulled by any accomplice 115 also using the present invention. So, the present invention considers three is underpinning aspects while throwing a digital help call 113. First, it gives the user a silent panic option that would only be sent to user's trusted friends and trusted protection services (both public 110 and private 108) outside coercion zone 103 (smartphones or PCs positioned outside a given distance around the incident). Second, if the digital help call 113 is not a silent one, any user of the present invention can receive it (including an accomplice 115) and from the smartphone of the victim 105 would be apparent that a help call was made. From both ways, the aggressor 106 could then coerce the user to cancel the panic call. For that reason, the present invention always applies a security check. Another reaction an aggressor could make is to immediately break, throw away or turn-off victim's smartphone, but in that case, the help call would have been thrown already. That is why the panic capture is so important as it will be explained in details in connection with FIG. 2 and FIG. 3. Third, the digital help call 113 is actually a way of sharing information about the victim 105 and his or her situation 100 even to unregistered users. So, the present invention will boost conventional emergency calls 114 as it will provide users (victims 105, their known 107, 108, their unknown 111 and unregistered 110 helpers) a way to stay updated in real-time regarding the situation 100. As a manner to avoid misuse by the aggressor 106 or his or her accomplice 115, the present invention considers a method for sharing the digital help call 113 via conventional emergency channels 114, flowing through the same chain of trust it would happen verbally, person-to-person.

As evidenced before, the effective capture of the panic signal is fundamental to trigger the chain of aid response. FIG. 2 depicts the states (and transitions) of the present invention's mobile application 200 in order to best fit user's contextual needs, especially when he is feeling fear or facing uncertainty 207.

In alert state 203, the mobile application can monitor smartphone's microphone and accelerometer in order to perceive several environmental events (e.g. verbal threats, screams, blasts, falls, taps and runs) and then automatically trigger public panic on behalf of the user. Thanks to this state and convenient switching user control as shown in FIG. 3, the present invention is capable of performing such intense environment sensing (a battery, processor and memory consuming process) even on smartphones with limited resources.

The implicit semantic of such alert state 203 also greatly reduces the occurrence of false positives because the user is implicitly telling the severity of the situation, which lets the sensing processes have lower thresholds and be much more responsive and effective.

Furthermore, the alert state 203 is a great and fundamental source of contextual information about the user for predictive security scenarios such as negative feedback controls and proactive advisory. For instance, if a smartphone is abruptly turned-off while in alert state 203, it is a much stronger security incident then the same fact in normal state 201 or private state 202. Another great sample scenario is to give the user advisory based on the history of places and times other users have put their mobile applications in alert state 203.

The other states (private 202, normal 201 and panic 204) and transitions (208, 205 and 206) are conventional to any security solution and are depicted in FIG. 2 in order to contextualize the use of alert state 203.

FIG. 3 depicts the usability resource and functionality the present invention has for switching of state and calling for help, considering the need for easy and quick switching between the four states depicted in FIG. 2 (an action a user will likely do many times a day) and how alert state 203 affects the quickness of the trigger panic action.

FIG. 3 represents a graphical usability design considering a generic smartphone touchscreen 300 in portrait orientation. This design has two basic graphical elements: the action button and state indicator 301 and the virtual “shift gate” 302—a movement ruler similar to a gearshift gate of a sports car. Note that button 301 and gate 302 have been embodied in FIG. 3 as a functional and usability description only, not in faithful representation of the actual resource of the present invention (with brand styles, shapes and colors).

According to the preferred embodiment of the present invention, the action button 301 indicates the running state of the mobile application 200 with four colors: gray, green, yellow and red, respectively representing the four states: private 202, normal 201, alert 203 and panic 204.

The action button 301 is first used to switch between private state 202 and normal state 201 (and vice-versa) whenever the user touches the screen on top of said button and slides down 304. The same movement 304 also switches to normal state 201, if the application is in alert state 203 or panic state 204, meaning alert or panic termination, respectively.

When in private 202 or normal states 201, the movement to trigger panic state 305 (to switch to panic state 204) is to touch the screen on the top of the action button 301, slide to one side of the shift gate 302 and then slide to the other side, according to the embodiment of the present invention.

When in private 202 or normal states 201, the movement 306 to switch to alert state 203 is to touch the screen on the top of the action button 301 and slide to one side of the shift gate 302. When in alert state 203, the same movement 306 triggers panic (switches to to panic state 204).

Note that FIG. 3 shows movements 305 and 306 in one order only, nevertheless it can happen in both directions.

If the smartphone has a generic proximity sensor 303, the action button 301 is disabled whenever the sensor indicates true in order to prevent accidental panic triggering or state switching.

During movements 304, 305 and 306, the state indicator 301 gradually changes its color between the initial, intermediate and final states, as explained above, in order to indicate to the user the meaning of his or her ongoing action.

Every time a status downgrade happens, that is, the user switches to a new status of lower severity than the former (considering the growing severity scale of private state 202, normal state 201, alert state 203 and panic state 204), the present invention applies a security check, as depicted in FIG. 4.

The same security check must be applied whenever the user may be supposed to be coerced. So this check is likely to be performed several times a day and must be convenient enough so that the user will neither reject the mechanism nor trigger false alerts of coercion, which are considered as silent panics, as it will explained in details below.

On the other hand, a coercer will always watch the user performing the security test. So it is mandatory not to reveal the result of a check while still taking the corresponding actions due to a failed one. That is why the capabilities explained above are so important to the overall effectiveness of the present invention.

FIG. 4 also represents a graphical usability design considering a generic smartphone touchscreen 400 in portrait orientation.

According to the preferred embodiment of the present invention, the check mechanism shows the user a set of sixteen pre-defined images of common class and easy to be memorized. Examples of such images may be vertebrates, invertebrates, tools, toys, vehicles, types of shoes, household items, among others.

Those sets of images are steady and common to all users of the present invention.

A specific user would have had previously selected one class of images and then secretly chosen the image he better identifies as an icon for his protection. These images are selected and prepared so that only intimate thoughts and feelings would reveal the user's choice.

The secret chosen image 401 is then shown to the user together with the others of the same class. The images are also shown to the user in a random order so as to make it hard for a potential coercer to figure out which is the user's secret image by just observing him, considering that the situations in which a user has to perform the security check are random and private by their own nature.

It should be noted that the actual number of images could be adjusted depending on the actual size of the touchscreen of a given specific smartphone, as it will be easily noted by a person skilled in the art. The innovative aspect the check mechanism is that a small number of standard images is enough to produce high uncertainty level to the coercer so he would rather not take the risk.

FIG. 4 also depicts that application of the present invention works in the same way on both correct 402 and incorrect 403 image selections by the user. If a failed check happens, the only people notified are trusted people outside coercion zone 103, as explained below.

In order to build up a comprehensive security solution, the present invention has to have the capability to orchestrate actions of many registered and unregistered users through several devices (smartphones and PCs).

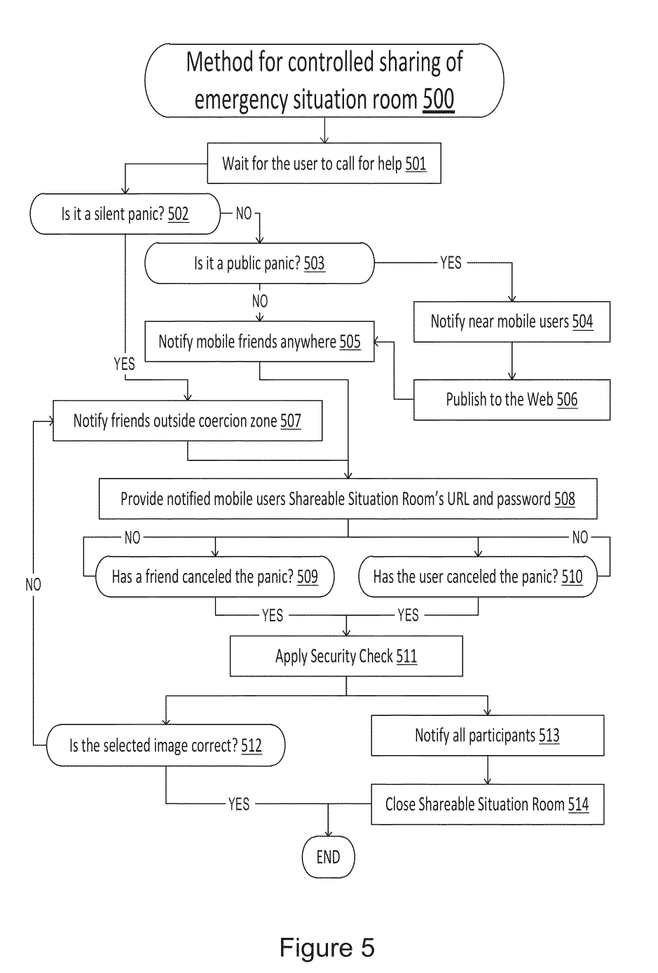

FIG. 5 depicts the method 500 of the present invention, which is mainly automated by web services integrated to smartphone and PC applications.

As showed in FIG. 5, the present invention waits for the user to call for help 501 and checks the panic type among the three types of panic provided by the present invention, namely: silent, private and public panics.

If it is a silent panic 502 (meaning coercion), the present invention gives no indication on the smartphone that a panic has been triggered and only people trusted by the user and outside the coercion zone 103 are notified 507.

If it is a private panic, all people trusted by the user are notified 505.

If it is a public panic 503, all people trusted by the user or near the epicenter of the incident by a given distance are notified 504 and a public notification (with limited sensitive information such as user's picture, first name, current location, body characteristics, blood type and chronic diseases) is sent to the web 506 (via a specific website and social networks).

Once the scope of notification is determined, all notified mobile users receive a specific short web URL and a secret security code. According to the preferred embodiment of the present invention, said specific short web URL may be for example http://abc.de/E1F2G, whereas said secret security code can be 3H4 for the shareable situation room of the incident 508.

Having the URL and security code, any person could call emergency services and either pass them (by any known means such as dictate, text, email, etc.) to the attendant or verbally coordinate with him, while supported by the present invention.

This situation room is available until the incident has been closed 514 by a trusted person 509 or if the user is not in distress any longer 510. This provides much more information about the user (such as his picture, full name, body characteristics, blood type, chronic diseases, home address, phone numbers, people of contact's first names and phone numbers) and the situation he is facing than the web notification 506 does. Additionally, it allows bidirectional coordination (via chat, positioning, pictures, etc.) with all helpers who had acknowledged the notification.

As above stated, a security check 511 is applied to whoever cancels the panic. If the check fails 512, another silent panic is issued regarding the person who has supposed been coerced. Just as important, the former incident is normally closed as if it were successfully checked 513.

It should be noted that the method 500 is a way of overcoming the established trade-offs between awareness and privacy, that is, a way to give society notice of what is happening to an individual (in order to help him) still giving him great control over his privacy, even during critical situations. The present invention is also a way of overcoming the trade-offs between openness and misapplication, that is, a way of amplifying the audience of notifications still avoiding misuse of them for crime and/or snooping purposes.

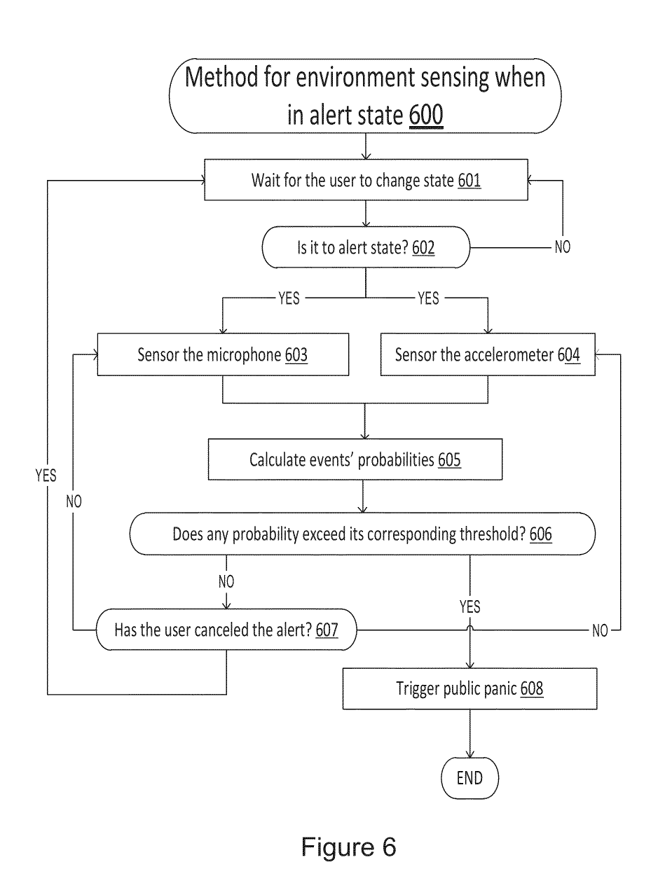

FIG. 6 depicts the method 600 of the present invention, which is automated by a mobile application.

As showed in FIG. 6, the present invention waits for the user to change the mobile application's state 601. If the new state is alert 602, then the mobile application starts sensing smartphone's microphone 603 and accelerometer 604 in order to capture events surrounding the user that could give signal that he is in distress.

Those events are captured as calculated probabilities 605 of a specific sound or movement read from said smartphone's sensors. The method 600 does not cover the techniques and calculations of such event probalilities, rather it covers the way of taking advantage of above stated alert state in order to sense and react to possible threats to the user in a feasible and effective way.

Therefore, the method 600 allows a broad range of event types to be captured, as follows, from the microphone: aggressiveness of voices, specific words pronounced (e.g. help me), acoustic signatures of firearm shot, as well as groans, sighs or screams; from the accelerometer: the user falling down, the user running, as well as the user performing specific movements with his smartphone (i.e. tapping or slipping a given number of times).

Each event type as above stated has a corresponding probability threshold and, after the mobile application has calculated the probability for each type of event, it checks whether any event threshold had been exceeded 606. If positive, the mobile application triggers an above stated public panic (i.e. switches to panic state) 608 on behalf of the user. If negative, the mobile application keeps sensing both microphone and accelerometer until the user cancels the alert (i.e. swiches to a state other than alert) 607.

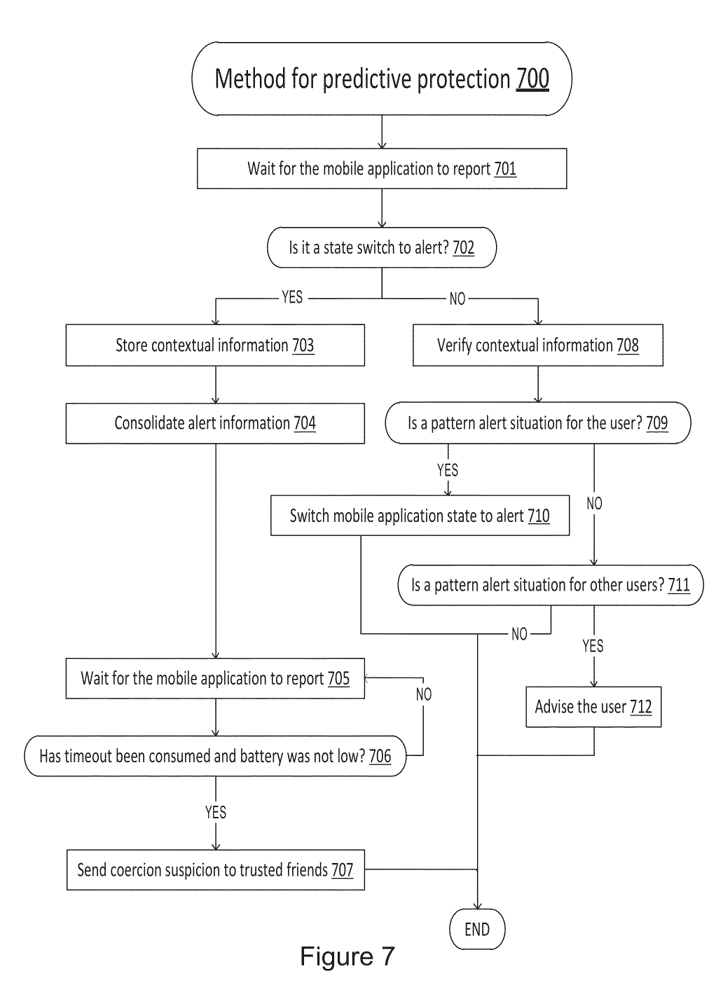

FIG. 7 depicts the method 700 of the present invention, which is automated by web services.

As showed in FIG. 7, the present invention waits for the mobile application of the present invention to report to web services 701 relevant changes regarding the user and his use of the mobile application. Those reports are done on regular basis (e.g. every 3 minutes) in order to keep web services updated with contextual information about the user and his safety (his location, activity, movement, etc.). Furthermore, every switch of the mobile application's state is relevant to user's protection and is reported together with his current location and time as well as the battery level and connectivity level at that moment.

After each report 701, the present invention checks if it is a switch to alert state 702. If positive, the present invention stores all information reported in order to build a history for the user 703. It also stores it in a consolidated history 704 for all users so as to produce a pattern analysis for each relevant correlation of region and time that alerts had been made. Then, the present invention waits for the next report for a specific time (e.g. 5 minutes) 705. If such time is up and the reported battery level is not critically low 706, then a coercion suspicion is sent to user's trusted friends 707 (as an above stated silent panic).

If the present invention's mobile application report is not a state switch to alert, then the present invention's web services analyze contextual information about the user (i.e. his location, activity, time and movement) 708 and compare to user's history of alert switching (e.g. every time he is arriving home at night) 709. If there is a pattern situation match, then said web services send a signal to said mobile application automatically switching its state to alert 710.

If no match is found in user's history, then said web services compare said reported contextual information with the consolidated history of all users. If there is a pattern situation match 711, then said web services send an advice message to the user 712 (through said mobile application) warning him that he is entering a potentially distressing situation.

The many features and advantages of the present invention are apparent from the written description, and, thus, it is intended by the appended claims to cover all such features and advantages of the present invention.

Although the concepts disclosed herein have been described in connection with the preferred form of practicing them and modifications thereto, those of ordinary skill in the art will understand that many other modifications can be made thereto within the scope of the claims that follow. Accordingly, it is not intended that the scope of these concepts in any way be limited by the above description, but instead be determined entirely by reference to the claims that follow.

1. A method for controlling the states of the mobile application, said method comprising:
representing an alert state in a way that a user could select said alert state indicating apprehension while still not in panic;
executing complex and resource consuming environmental sensing of microphone and accelerometer in a cost-effective manner due to the usage of said alert state as a means of capturing the need for it; and
reporting web services any state switching together with other contextual information so that a history can be built.

2. A method as in claim 1, wherein in alert state and effectively sensing smartphone's microphone, said mobile application can do one or more of the following automatic analysis:
the probability of aggressiveness of voices captured;
the probability of specific words being pronounced;
the probability of acoustic signatures of firearm shot being captured; and
the probability of groans, sighs or screams being captured.

3. A method as in claim 1, wherein in alert state and effectively sensing smartphone's accelerometer, said mobile application can do one or more of the following automatic analysis:
the probability of the user had fallen down;
the probability of the user is running; and
the probability of the user had performed specific movements with his smartphone.

4. A method as in claim 1, wherein if said probabilities surpass a given threshold, then an automatic help call is done on behalf of the user.

5-13. (canceled)
